(19) United States
(12) Patent Application Publication
(10) Pub. No.: US 2026/0259814 A1
(43) Pub. Date: Sep. 3, 2026

(54) Efficient Page Prefetching with Flexible Prefaulting

(71) Applicant: MEXT Corporation, Santa Clara, CA (US)

(72) Inventors: Carl WALDSPURGER, Palo Alto, CA (US); David P. REED, Needham, MA (US)

(73) Assignee: MEXT Corporation, Santa Clara, CA (US)

(21) Appl. No.: 19/555,848

(22) Filed: Mar. 3, 2026

Related U.S. Application Data
(60) Provisional application No. 63/766,348, filed on Mar. 3, 2025.

(51) Int. Cl. G06F 11/34; G06F 12/02

(52) U.S. Cl. CPC G06F 11/3452; G06F 11/3409; G06F 12/0246

(57) ABSTRACT

A memory management method and system are provided for a computing system that includes an operating system (OS) that supports virtual memory and that accesses relatively faster memory and relatively slower memory. Which memory pages in a virtual memory space an application will access are predicted. At least one of the predicted memory pages is prefetched from the relatively slower memory into the relatively faster memory. For the memory page that has been prefetched, a quantitative prediction function of an estimated cost of incorrect early fault resolution and an estimated performance benefit of correct early fault resolution are computed. Before access by the application of the prefetched memory page, the invention selectively prefaults and resolves a corresponding fault on the memory page when the estimated performance benefit of correct early fault resolution is greater than the estimated cost of incorrect early fault resolution.

### REFERENCE TO RELATED APPLICATIONS

This application claims priority of U.S. Provisional Patent Application No. 63/766,348, filed 3 Mar. 2025.

### TECHNICAL FIELD

This application relates to memory management in computing systems.

### BACKGROUND OF THE INVENTION

Predicting future memory accesses or page faults makes it possible to fetch data that is likely to be needed in advance. Such prefetching hides the latency of accessing data stored in a slower far memory, such as pages that have been swapped out to local flash storage or remote DRAM, by moving them into near memory, such as local DRAM, which is generally much faster relative to the far memory. Existing techniques for predicting future accesses include both heuristic approaches and the use of ML-based models. As is well known in the field of computer science, “local” memory is the high-speed, temporary storage that is included in most computing systems, physically located close to or directly on a processor (CPU or GPU) for rapid access.

Current operating systems commonly employ simple heuristics that prefetch the next few pages following a fault. For example, Linux can be configured to prefetch pages following a page fault that are either sequential in the virtual address space of the faulting process, or sequential in the physical swap storage space, as described in Ying Huang, “mm, swap: VMA based swap readahead”, LWN Article, 2017. More sophisticated heuristic prefetchers can detect stride-based patterns among the virtual addresses of pages referenced in memory access streams; two examples of such systems are described in Al Maruf et al., “Effectively Prefetching Remote Memory with Leap”, in ATC 2020, and Li et al., “HoPP: Hardware-Software Co-Designed Page Prefetching for Disaggregated Memory”, in HPCA 2023.

Machine learning can also be applied to predict future memory accesses. For example, prior research on ML-based models for cache-line prefetching in hardware processors has proposed predicting future cache-line accesses based on the addresses of recent cache misses. Such systems are disclosed, for example, in Hashemi et al., “Learning Memory Access Patterns”, in ICML 2018; Shi et al., “A Hierarchical Neural Model of Data Prefetching”, in ASPLOS 2021; and Zhang et al., “Fine-Grained Address Segmentation for Attention-Based Variable-Degree Prefetching”, in CF 2022.

At the operating system level, the applicant in the present invention-MEXT Corp.—has pioneered the use of software ML-based models to predict future page accesses based on the addresses of recent page faults as disclosed in, for example, U.S. patent application Ser. No. 18/751,088, (Smerdon et al., “Intelligent, Predictive Memory Management System and Method”), filed 21 Jun. 2024, the contents of which are hereby incorporated by reference.

Both heuristic and ML-based techniques typically fetch predicted pages from slower far memory in advance, caching them in faster near memory. For example, a predicted page may be fetched from a swap area located in flash storage, and placed into a cache in local DRAM. When a page fault occurs, a hit in this cache allows the fault to be resolved relatively quickly, without accessing far memory.

However, such faults still incur significant overheads. The page fault exception itself interrupts the execution of an application process, causing a switch from user-mode to kernel-mode to execute the OS page fault handler. The handler must allocate a physical page, copy the relevant page contents from the cache into this newly allocated page, update accounting information, and map the page into the page table associated with the application before resuming its execution. While these steps are typically less expensive than the cost of performing I/O to far memory in local or remote storage, they can still degrade application performance significantly. Indirect costs of page-fault handling, such as cache pollution, can also result in additional non-trivial application slowdowns.

Such page-fault handling overhead can be eliminated by prefaulting predicted pages, effectively performing the costly page-fault handling steps before the application attempts to access a page. In other words, full end-to-end page-fault handling is triggered early. Such prefaults need not cause any interruptions to application execution, as predicted pages are mapped into the application's virtual address space before they are accessed. This approach has also been referred to as early PTE injection, since mapping a predicted page into the application virtual address space involves updating an entry in the page table (PTE), which is a data structure typically maintained within physical memory.

Prefaulting predicted pages offers the possibility of running an application with negligible overhead, despite having a substantial portion of its pages located in far memory. However, an important limitation is that an incorrect prediction becomes more expensive with this approach. Reclaiming an unaccessed prefaulted page typically requires swapping it out again, instead of simply evicting it from a page cache.

If a mispredicted page was not accessed, in theory this extra swap-out need not require any I/O, as a copy of the page still resides in swap. However, some operating systems, such as Linux, do not currently track this correspondence for anonymous (non-file-backed) pages, so it is unable to benefit from discarding clean pages without performing I/O. In some cases it may also be possible to avoid costly invalidations and shootdowns in the Translation Lookaside Buffer (TLB), which is a specialized, high-speed hardware cache within a computer's Memory Management Unit (MMU) that stores recent virtual-to-physical address translations; Linux avoids the TLB invalidation if the page hasn't yet been accessed (using compare-and-swap on the PTE to check the A bit).

Another challenging issue is that eliminating most page faults also eliminates most of the input data needed to inform heuristics and train ML prediction models. Paradoxically, the more effective prefaulting is at eliminating page faults, the less knowledge remains available to guide heuristics or to train ML-based prefetchers about application memory access patterns. To address these problems, prior research has proposed introducing new hardware for collecting page access traces, but this is not supported by existing processors.

What is needed is a method that can reduce or eliminate the overhead associated with faulting on predicted pages, while still retaining the ability to capture the page access information needed to inform predictors. Ideally, such methods should be implementable in software on commodity processors.

### SUMMARY OF THE INVENTION

Embodiments of the invention provide a memory management method and corresponding system implementation for use in a computing system, in which the computing system includes an operating system (OS) that supports virtual memory and that accesses first, relatively faster memory and second, relatively slower memory. Which memory pages in a virtual memory space an application will access are predicted, for example using a neural network-based ML routine. At least one of the predicted memory pages is prefetched from the relatively slower memory into the relatively faster memory. For at least one of the memory pages that has been prefetched, a quantitative prediction function of an estimated cost of incorrect early fault resolution and an estimated performance benefit of correct early fault resolution is computed. Before access by the application of the at least one prefetched memory page, the invention selectively prefaults and resolves a corresponding fault on the at least one memory page when the estimated performance benefit of correct early fault resolution is greater than the estimated cost of incorrect early fault resolution.

In a preferred embodiment, for the at least one memory page that has been prefetched, at least one corresponding misprediction value P_{bad} is derived corresponding to a probability that the respective memory page is not accessed according to a predetermined timeliness criterion. The quantitative prediction function may be computed as C×P_{bad}<B×(1−P_{bad}), where C is the cost of incorrect early fault resolution and B is the estimated performance benefit of correct early fault resolution. This formula may instead be computed in terms of P_{good}, where P_{good} =(1−P_{bad}).

In some embodiments, the predicted memory pages are classified into groups and a separate misprediction value is derived for each of the groups. The groups may, for example, be chosen based on at least one of: a respective predictor confidence level; a respective process identifier; a respective address space identifier; and a respective virtual memory region.

In some embodiments, the system deliberately refrains from performing the selective prefaulting for a subset of predicted memory pages and estimating the misprediction value as a function of observed actual page faults. The misprediction value may optionally be smoothed over time using a moving average. The subset may, furthermore, be selected randomly; one example of a selection method is hash-based spatial sampling over a subset of page address bits and selecting only pages with address hashes in certain ranges.

The rate of prefaulting may be adjusted dynamically according to the observed actual page faults from the subset.

The step of deriving the misprediction value P_{bad} may include clearing access indicators associated with the prefaulted memory pages upon prefaulting the memory pages, scanning the access indicators, and identifying which of the prefaulted memory pages have been accessed since a previous identification time after clearing of the access indicators. The access indicators may be A-bits in page table entries for the respective prefaulted memory pages, in which case the step of scanning the access indicators may be based on a sampled subset of the A-bits.

In some embodiments, as part of the selective prefaulting operation, a page fault may be invoked earlier than it would otherwise occur by causing a user-mode thread to access the selectively prefaulted at least one memory page. The user-mode thread may, for example, be a background thread associated with an address space of the application.

One way to initiate selective prefaulting may take place within a kernel of the OS by issuing an upcall to a user-mode thread.

The step of selective prefaulting may include mapping the memory page into a single virtual address space while delaying modifying page table entries (PTEs) associated with other address spaces.

Some embodiments include determining whether a prefaulted physical page has been accessed by examining access indicators for multiple virtual mappings of the at least one memory page.

The operation of predicting which memory pages the application is likely to access may be carried out by a trainable predictor, such as a neural network-based ML routine. As an optional feature in some embodiments, training data for the predictor is generated despite prefaulting operations that eliminate page faults. The training data may be generated by scanning access indicators during a defined training window. In some embodiments, page faults are allowed and made possible for training of the predictor by disabling prefaulting for selected memory regions, which may be selected using, for example, spatial sampling or randomly, such as by using hash-based spatial sampling over a subset of page address bits and selecting only pages with address hashes in certain ranges. in some embodiments the selected memory regions may be changed dynamically.

The prefetching and prefaulting operations used in the invention may be carried out asynchronously with respect to execution of the application. For example, the system may allow the application to continue running, unblocked, during prefaulting.

### BRIEF DESCRIPTION OF THE DRAWINGS

FIG. 1 illustrates the main hardware and software components of a system that incorporates the invention.

### DETAILED DESCRIPTION

In general, the invention provides various embodiments that improve over existing prefetching mechanisms in a computing system using what here is termed “adaptive prefaulting”, which comprises a novel operation applied to a prefetched page (which may be generalized to whatever memory unit is prefetched, if a different granularity is implemented) that reduces overhead (effectively to zero) when the application later accesses it. Note first that “prefaulting” does not mean deliberately causing any kind of memory access fault in addition to what would otherwise occur in the normal course of process execution; rather, as used here, “prefaulting” refers to a pre-mapping operation that is carried out as an extra step for a prefetched page, in order to reduce the overhead (effectively to zero) when the application later accesses it. As will become clearer from the description and examples below, “prefaulting” in the sense of this invention can thus be viewed as a method for optimistic fault resolution prior to a page miss, that is, anticipatory resolution of a likely page miss.

Eliminating page faults via the conventional notion of prefaulting makes incorrect predictions more expensive. This invention thus provides a mechanism in which pages are prefaulted only when doing so is expected to improve performance. One feature of the invention is thus the implementation of a quantitative cost-benefit decision. Given the estimated cost C of an incorrect prediction and the estimated benefit B of a correct prediction (e.g. average latency decrease by avoiding a page fault), prefaulting will be a net good, that is, computationally advantageous, when C×P_{bad}<B×P_{good}, where P_{good}=(1−P_{bad}) and P_{bad} is the probability of a bad prediction. (Computation×based×on P_{good} instead of P_{bad} is of course a trivial change that gives the same result.) A bad prediction (or misprediction) is defined as a predicted page that has been prefetched but that is not accessed according to a predetermined timeliness criterion, for example, within some predetermined or adjustable period of real time or number of memory accesses, or before the predicted page is reclaimed (evicted). In other words, P_{bad} is a value that represents the probability that a page was prefetched “unnecessarily”.

The definition of “cost” is an implementation choice. One definition of cost may, for example, be the increase in average latency, which may be measured using known mechanisms. As another example, since the page associated with a “bad” prefault may need to be swapped out again (e.g. as in Linux), cost may also be defined in terms of the amount of bandwidth consumed to swap storage. As yet another example, writes to swap storage may incur other costs such as the time needed for garbage collection in SSDs, limited flash endurance, etc. It would also be possible to define cost as a function of more than one such factor, such as a weighted linear combination of values representing both latency and required bandwidth as a function of available bandwidth. Moreover, the chosen value for C, whether single-or multi-parameter, need not be static, but could be made adjustable, for example, as a function of current fast memory or bandwidth availability.

In some embodiments, a heuristic or machine learning (ML)-based trainable predictor is included to compute one or more prediction accuracy values. U.S. patent application Ser. No. 18/751,088 (Smerdon et al.) referenced above discloses an example of an ML routine that may be used to implement the predictor. Other suitable ML neural network configurations that have been used successfully in prototypes of the invention include multi-layer perceptrons (MLP) and transformers. Depending on the hardware and software configurations of a given computing platform, as well as the nature of the native prefetching routine, system designers familiar with prefetching techniques will be able to choose a suitable ML configuration for the predictor

Examples of such prediction accuracy values include confidence estimates for each prediction, such as “low” and “high”, or a numerical accuracy estimate that may, for example, be grouped into different confidence levels or bands. In such cases, it will typically be advantageous to maintain separate P_{bad} values for each confidence level, and to make distinct prefaulting cost-benefit decisions per level. More generally, alternative or additional features can be used to segregate predictions into different groups or classes, each with their own P_{bad} estimates, such as by process identifier, address-space identifier, coarse-grained enclosing memory region, etc.

### Feedback via Sampling

Without prefaulting, measuring P_{bad} exactly is straightforward, since an access to a predicted page causes a page fault, providing direct feedback about accesses. However, with prefaulting, measuring P_{bad} is challenging, as there is no comparable way to interpose on ordinary non-faulting memory accesses. One embodiment therefore uses sampling to generate a statistical estimate for P_{bad}.

In one embodiment a small percentage of predicted pages is deliberately not prefaulted. For example, the adaptive prefaulting system may randomly prefault 95% (or any other chosen percentage) of predicted pages, but not prefault the remaining pages, for example, 5%, instead observing their future page faults (or absence) to statistically estimate the true misprediction rate. When the cost of mispredictions outweighs the benefit of prefaulting, prefaulting can be disabled. Conversely, when the benefit of prefaulting outweighs the cost of mispredictions, prefaulting can be enabled. Since P_{bad} will often vary dynamically, it may instead be advantageous to adapt the prefaulting rate, e.g. prefaulting each predicted page with a probability that increases when its expected benefit is observed to outweigh its cost, and decreases when the expected cost outweighs its benefit. Known techniques such as simple or exponentially weighted moving averages (EWMAs) may be used to smooth the value of P_{bad} used for such adaptation.

### Feedback via Scanning

An alternative approach to measuring P_{bad} without incurring page faults is to scan access indicators such as the access bits associated with prefaulted pages. When a page is prefaulted, the access bit (A-bit) in the page table entry (PTE) that maps the page is initially cleared in software. If the page is subsequently accessed, the hardware page-table walker will set the A-bit in its PTE. Afterward, a software module programmed for the purpose may check the A-bit to see if the page has been accessed since it was last checked. To reduce the overhead of A-bit scanning, sampling may also be employed. For example, scanning A-bits for 5% of prefaulted pages will yield a statistical estimate of P_{bad}.

Note that some physical pages may be mapped into multiple virtual address spaces, e.g. to support explicit memory sharing across different processes, or for memory regions that are mapped copy-on-write. In practice, such many-to-one mappings are much less common than one-to-one mappings. However, to precisely determine if a physical page that was prefetched from far memory has been accessed, the access bits associated with all of its virtual mappings should preferably be checked to see if any of them are set (performing a logical OR across the A-bits in their respective PTEs). For example, the Linux kernel identifies the set of virtual pages that map to the same physical page by consulting a reverse mapping (rmap) data structure, which is a relatively expensive operation.

Since predictions are typically made with respect to a single address space, embodiments may safely ignore the potential for sharing, prefaulting the page into that single address space by updating a single PTE, without incurring the cost of an rmap lookup. Thus, the selective prefaulting operation may include mapping the memory page into a single virtual address space while delaying modifying PTEs associated with other address spaces, for example until the OS later modifies those PTEs, in response to a page fault, or by some other non-native prefetching routine.

Subsequent accesses to the same physical page through other mappings will still incur page faults, and thus do not require A-bit scanning to detect accesses. Other embodiments may choose to prefault a page into all relevant address spaces, and to scan the A-bits associated with each mapping to detect accesses.

### Exposing Information for Predictor Training

Eliminating page faults via prefaulting will in general hide accesses that may be needed as input data to inform heuristics and train ML prediction models. In fact, as more page faults are eliminated by prefaulting, less information about memory access patterns remains available for training, and this may ultimately lessen predictor accuracy and reduce the general effectiveness of prefetching.

Many heuristics and ML-based prediction models require a set of recent faults or page accesses as inputs and generate a set of (zero or more) predictions for future page accesses. Training predictors commonly requires comparing their predictions to a window of subsequent page accesses that actually occur. For example, in a neural network model, feedback regarding correct and incorrect predictions is used to compute a loss function, which is used to adjust weights in order to improve future predictions.

### Temporal Sampling to Reduce Scanning Overhead

In some embodiments, training is performed only periodically, in order to reduce overhead compared to continuous training. In such cases, the “ground truth” about prediction correctness for associated prefaulted pages may be determined via access bit scanning. First, the A-bits in the PTEs for all prefaulted pages associated with the prediction are explicitly cleared, as discussed earlier, in order to monitor future accesses.

The first time a page is accessed after it has been prefaulted, the processor hardware will reliably set the A-bit in its associated PTE. However, if software subsequently clears the A-bit after this first access, then ensuring that hardware reliably sets the A-bit again requires the additional step of invalidating entries cached in the TLB. For adaptive prefaulting as described above, no such invalidation is required, since to compute P_{bad}, it is necessary only to determine if a page has ever been accessed since it was prefaulted. In contrast, for predictor training, the system should monitor predicted pages for accesses that occur in a window after the predictions are made. Since these pages may have already been prefaulted as the result of some earlier prediction, any A-bits in their associated PTEs that are already set must be explicitly cleared.

In most processor implementations, once a translation is cached in the translation lookaside buffer (TLB) with the A-bit already set, the hardware will not re-check or reset that bit in the PTE until it is forced to do a new page-table walk. Simply clearing the A-bit in memory does not invalidate the cached TLB entry. Thus, clearing the A-bit in the PTE without invalidating (aka “shooting down”) corresponding TLB entries is insufficient, as subsequent accesses continue to use the cached translations, and thus the hardware will never notice that the A-bit was cleared in memory.

TLB entries can be invalidated explicitly by software, such as by executing the x86 INVLPG instruction. Many processors also support TLB entries that are tagged with an address space identifier (ASID), such as the process context identifier (PCID) used in modern x86 implementations. On such processors, it is possible to invalidate all TLB entries associated with a PCID at once using the x86 INVPCID instruction, which may be more efficient than using separate INVLPG instructions for each page to monitor for accesses.

Because each processor core has its own TLB, the entry must be invalidated on all cores that may have cached the mapping. This is commonly implemented using expensive inter-processor interrupts (IPIs) to execute INVLPG or INVPCID on remote cores. Since A-bit scanning is used only to inform performance optimizations, and does not affect correctness, skipping expensive shootdowns on remote cores may still yield sufficient accuracy in some cases. Various embodiments may choose to make different tradeoffs between accuracy (faithfully tracking all accesses to predicted pages) vs. overhead due to the cost of clearing A-bits and invalidating associated TLB entries.

TLB invalidations should preferably be performed at least on the core that caused the fault which generated the predictions, and optionally on other cores via TLB shootdowns. After an appropriate period of time (or number of memory accesses or other windowing criteria) their A-bits are checked to see if they were accessed in a timely manner after the predictions were generated. Note that the invalidations performed by this approach will cause additional TLB misses, but the latency of a TLB miss is typically negligible compared to a page fault.

As noted earlier, some physical pages prefetched from far memory may be mapped into multiple virtual address spaces. Fortunately, predictors commonly generate predictions with respect to a single virtual address space, and training involves assessing the correctness of predictions only within that address space. As a result, there is generally no need to consider possible mappings from other virtual address spaces, which avoids the need to consult a reverse mapping (rmap) data structure.

For predictors that generate predictions as deltas within a bounded range of offsets, it may also be desirable to similarly scan A-bits associated with (all or a sample of) non-predicted pages within the range, in order to provide training examples of false negatives, i.e. accesses that should have been predicted, but were not.

### Spatial Sampling to Disable Prefaulting for Training

Yet another approach that the system according to this invention may implement is to disable prefaulting for selected regions of memory, and to restrict training to page faults that occur in those regions. A small fraction of possible regions may then be selected statistically, with a chosen distribution such as, for example, a uniform random distribution. For example, some embodiments may employ hash-based spatial sampling, such as is described in Waldspurger et al., “Efficient MRC Construction with SHARDS”, in FAST 2015, computing a hash over a subset of page address bits, and selecting only pages with address hashes in certain ranges. The selected regions should form a representative sample of an address space, and because they have prefaulting disabled, accesses within them will generate the usual stream of page faults as training inputs. Assuming a low sampling rate (e.g. ~5%), most regions (e.g. ~95%) will remain unsampled and keep prefaulting enabled, benefiting from increased performance.

In some embodiments, the set of sampled regions and/or the sampling rate may be changed dynamically, e.g. to sample different portions of the address space over time. In some embodiments, spatial sampling may be used instead of temporal sampling (as described in the above-mentioned Smerdon et al.) to reduce overhead by limiting training.

### User-Mode Prefaulting

In an alternative embodiment, the system causes a user-mode thread associated with the application address space to issue a memory load that reads from the swapped-out page that is to be prefaulted. The resulting page fault then invokes the normal page-fault handling process in the kernel, swapping in the page and mapping it into the application address space. After this early prefault, a subsequent access to the predicted page will not incur a page fault. Note that, in this embodiment, for a correctly predicted page, no additional fault is being caused, but rather a fault is caused to occur earlier than it otherwise would.

One option is to transparently inject an additional prefault thread into the application. This thread may then communicate with other existing prefault-administering software via shared memory, e.g. receiving addresses for pages to prefault (by simply reading from them). An additional advantage of having such a controlled background thread running in the context of the application's virtual address space is that it may serve as a more localized controller, with access to application state that might help inform predictions. It would also be possible to enable communication between the prefault thread and the prefault-administering kernel software using the known technique of virtual dynamic shared object (vDSO) page(s) in the process, which could also be set up during application startup.

Alternatively, it would also be possible for the kernel code of the invention to perform an upcall into (any) user-space thread associated with the application, in order to cause it to prefault a page.

### Asynchronicity

The prefaulting method according to this invention may be performed asynchronously and concurrently with application execution. When an application context (process or thread) faults on a page, it may be blocked until the fault is resolved, stalling application progress. Because prefetching and prefaulting are performed asynchronously (e.g. in a separate system context), they are off the critical path. The latency they incur to complete therefore need does not require stalling the application, provided that they complete before the application accesses the page.

### System Implementation

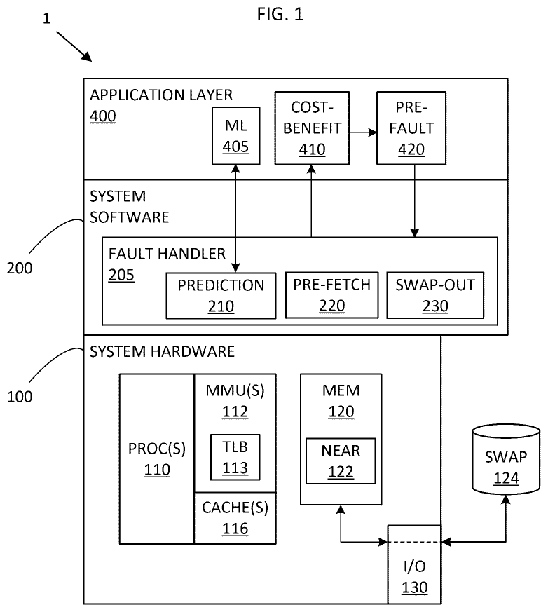

FIG. 1 illustrates the main hardware and software components of a system 1, that is, a computing platform, that incorporates the invention. As in other computing platforms, the system will include system hardware 100, system software 200, and an application layer 400 that runs in non-privileged mode. The system software 200 will include some form of operating system (OS). The system hardware 100 will include one or more central processors 110 and will include or be able to access both volatile and non-volatile storage. To enable this access, each processor 110 will be associated with a respective memory management unit 112, including a TLB 113 and at least one cache 116. In particular, the hardware system will include or be able to access memory units 120, at least one of which is assumed here to be the memory into which pre-fetched pages are to be swapped, labeled as the “near” memory 122 in the figure.

The memory 120 is also connected, using any conventional I/O device, driver, etc., as needed, to one or more “swap” memory units 124 to which pages are swapped out and from which pages are swapped in. In one prototype of the invention, the near memory 120 was DRAM and the swap memory 124 was a flash memory unit, for example an NVMe SSD device. In many cases the swap memory 124 will be slower than the near memory 122, but this is not a necessary limitation for the invention. Although the swap memory 124 is shown in the figure as being external to the system hardware 100 as such, it may also be considered part of system hardware and may, in some implementations, in fact be configured as an integral component of the system components, needing no I/O 130 for external communication. The swap memory 124 may, for example, simply be implemented with a slower technology, a couple examples of which are Compute Express Link (CXL) memory, and Intel Optane Persistent Memory (PMem) DIMMs.

Other standard components such as I/O units 130 may also be included to enable communication with other components, entities and systems over any known type of network, wireless or wired, including, in the illustrated embodiment, the external swap memory 124. The processor-executable code organized as software modules that cause the processor(s) to carry out the various computations, routines, and functions described below (including components 405, 410 and 420 shown in FIG. 1) may be stored and thus embodied in the volatile or non-volatile memory or other storage components.

The system software layer 200 will include standard components that are not illustrated in FIG. 1 because they are so well known. One such standard component, however, that is relevant to the invention is the fault handler 205, which in turn will include components 210, 220 and 230 to predict which pages an application is likely to be needed, to implement whatever prefetching policy is implemented, and to direct the needed memory swaps.

A software component 410 is included in the application layer inputs information concerning predicted pages from the fault handler 205 and then which to carry out the cost-benefit analysis described above. The results of the cost-benefit analysis are passed to a prefaulting component 420, which then carry out the various procedures for determining which pages to prefault and cause the corresponding prefaults accordingly. The respective software modules, in particular a swap component 410, a delta computation component 420 and a prediction component 430 (all described below) will thus comprise processor-executable code that, when run by the processor(s) 110, cause the processor(s) to carry out the corresponding functions. A predictor, such as a machine learning (ML) routine 405 is preferably also included in the application layer to input data for training it to improve its ability to efficiently predict, that is, select, memory pages for prefetching. This may be done independently of the prediction component 210 in the OS 200, or it may be programmed to inform or override the computing platform's “built-in” prediction routine.

Although the software components 405, 410, 420 are shown in FIG. 1 as being separate components, they may of course be combined into a unified body of code if this is preferred, different sections of which perform the respective functions.

Any of various mechanisms may be implemented to enable transfer of necessary information between the OS to the user-level components that are used in the embodiments of this invention. For example, the software components 405, 410, 420 needs information regarding what memory accesses the OS is attempting, what the OS chooses to swap in and out, what the results (for in terms of reduced latency) of the swapping are, to be able to cause (and sometimes refrain from) prefaulting, etc. To train the ML routine in software component 405, for example, which acts as the predictor, success/failure data is needed, as well as data from which to determine cost/benefit and P_{bad}.

One mechanism that may be included in embodiments of the invention is described in the U.S. patent application Ser. No. 18/751,088, (Smerdon et al.) filed 21 Jun. 2024, mentioned above, and the contents of which are there incorporated by reference. That application discloses a “telemetry reporting component” and an “intercepted page/page swap/out component”, which may communicate with the client system either over a network or via a shared memory interface. “Telemetry” refers to the information that is sent concerning the client's running computation to an AI Learning and Prediction Processing component, which may also be used as the ML component 405 of this invention. This information may include, for example, details about processes running in the client, their address space structures, recent history (for example, the last n misses and possibly even hits, instead of just one). As its name implies, the intercepted page/page swap/out component performs the known functions of page swapping (both swap-out, and swap-in), for example, between different tiers of memory devices.

Different techniques may be used to implement the swap-out component in Smerdon et al. such as the known Linux kprobes mechanism or a custom block device. One example is the operating system component known as a Block Device Driver. Instead of using a conventional block storage device for swap space, however a dynamically installed “Virtual Block Device” is used in Smerdon et al., implemented in software only, and which sends requests and pages across a dedicated communications link. This communications link may in turn be implemented either over a network path or through shared physical memory.

Instead of the “kprobes” and “virtual block device” techniques mentioned in Smerdon et al., embodiments of this invention may incorporate the known “ftrace” routine, which is a built-in Linux kernel tracing framework used to monitor, debug, and analyze system performance, latency, and function calls directly within the kernel. Like kprobes, ftrace is a Linux-specific tracing framework for hooking kernel routines without modifying core kernel code. Other operating systems have similar tracing and probing interfaces, such as DTrace, which was developed for Solaris and is now also available on FreeBSD and MacOS. Yet another option available on several operating systems, including Linux, is the “extended” Berkeley Packet Filter known as eBPF.

As yet another alternative, it would be possible to modify the OS kernel code directly to add the necessary functionality or even to implement the prefetching and prefaulting features of this invention as part of the OS itself.

1. A memory management method for a computing system, in which the computing system includes an operating system (OS) that supports virtual memory and that accesses relatively faster memory and relatively slower memory, the memory management method comprising:
predicting which memory pages in a virtual memory space an application will access and prefetching at least one of the predicted memory pages from the relatively slower memory into the relatively faster memory;
for the at least one memory page that has been prefetched:
computing a quantitative prediction function of an estimated cost of incorrect early fault resolution and an estimated performance benefit of correct early fault resolution; and
before access by the application of the at least one prefetched memory page, selectively prefaulting and resolving a corresponding fault on the at least one memory page when the estimated performance benefit of correct early fault resolution is greater than the estimated cost of incorrect early fault resolution.

2. The method of claim 1, further comprising:
for the at least one memory page that has been prefetched, deriving at least one corresponding misprediction value P_{bad} corresponding to a probability that the respective memory page is not accessed according to a predetermined timeliness criterion; and
computing the quantitative prediction function as C×P_{bad}<B×(1−P_{bad}), where C is the cost of incorrect early fault resolution and B is the estimated performance benefit of correct early fault resolution.

3. The method of claim 2, further comprising classifying the predicted memory pages into groups and deriving a separate misprediction value for each of the groups.

4. The method of claim 3, in which the groups are chosen based on at least one of: a respective predictor confidence level; a respective process identifier; a respective address space identifier; and a respective virtual memory region.

5. The method of claim 2, further comprising:
deliberately refraining from performing the selective prefaulting for a subset of predicted memory pages; and
estimating the misprediction value as a function of observed actual page faults.

6. The method of claim 5, further comprising selecting the subset randomly.

7. The method of claim 5, further comprising adjusting a prefaulting rate dynamically according to the observed actual page faults from the subset.

8. The method of claim 5, further comprising smoothing the misprediction value over time using a moving average.

9. The method of claim 2, in which the step of deriving the misprediction value P_{bad} includes:
clearing access indicators associated with the prefaulted memory pages upon prefaulting the memory pages; and
scanning the access indicators and identifying which of the prefaulted memory pages have been accessed since a previous identification time after clearing of the access indicators.

10. The method of claim 9, in which the access indicators are A-bits in page table entries for the respective prefaulted memory pages.

11. The method of claim 10, in which the step of scanning the access indicators is based on a sampled subset of the A-bits.

12. The method of claim 1, further comprising, as part of the selective prefaulting, invoking a page fault earlier than it would otherwise occur by causing a user-mode thread to access the selectively prefaulted at least one memory page.

13. The method of claim 12, in which the user-mode thread is a background thread associated with an address space of the application.

14. The method of claim 12, further comprising initiating, within a kernel of the OS, the selective prefaulting by issuing an upcall to a user-mode thread.

15. The method of claim 1, wherein the step of selective prefaulting includes mapping the memory page into a single virtual address space while delaying modifying page table entries (PTEs) associated with other address spaces.

16. The method of claim 2, including determining whether a prefaulted physical page has been accessed by examining access indicators for multiple virtual mappings of the at least one memory page.

17. The method of claim 1, in which the step of predicting is carried out by a trainable predictor, the method further comprising generating training data for the predictor despite prefaulting operations that eliminate page faults.

18. The method of claim 17, wherein training data is generated by scanning access indicators during a defined training window.

19. The method of claim 17, further comprising allowing page faults for training of the predictor by disabling prefaulting for selected memory regions.

20. The method of claim 19, in which the selected memory regions are selected using spatial sampling.

21. The method of claim 20, in which the selected memory regions are selected randomly.

22. The method of claim 21, in which the selected memory regions are selected using hash-based spatial sampling over a subset of page address bits and selecting only pages with address hashes in certain ranges.

23. The method of claim 19, further comprising dynamically changing the selected memory regions.

24. The method of claim 1, further comprising performing the steps of prefetching and prefaulting asynchronously with respect to execution of the application.

25. The method of claim 24, further comprising leaving the application running, unblocked, during prefaulting.

26. A memory management system for a computing system that includes at least one processor, an operating system (OS) that supports virtual memory, first memory that is faster than second memory, the memory management system including:
a prediction software component comprising processor-executable code configured to predict which memory pages in a virtual memory space an application will access and to cause prefetching of at least one of the predicted memory pages from the second memory into the first memory;
a cost-benefit software component comprising processor-executable code configured, for the at least one memory page that has been prefetched, to compute a quantitative prediction function of an estimated cost of incorrect early fault resolution and an estimated performance benefit of correct early fault resolution; and
a prefaulting software component comprising processor-executable code configured such that, before access by the application of the at least one prefetched memory page, the prefaulting software component causes selective prefaulting of and resolves a corresponding fault on the at least one memory page when the estimated performance benefit of correct early fault resolution is greater than the estimated cost of incorrect early fault resolution.

27. The memory management system of claim 26, in which the cost-benefit software component is further provided:
for the at least one memory page that has been prefetched, for deriving at least one corresponding misprediction value P_{bad} corresponding to a probability that the respective memory page is not accessed according to a predetermined timeliness criterion; and
for computing the quantitative prediction function as C×P_{bad}<B×(1−P_{bad}), where C is the cost of incorrect early fault resolution and B is the estimated performance benefit of correct early fault resolution.

28. The memory management system of claim 27, in which the cost-benefit software component is further provided to classify the predicted memory pages into groups and to derive a separate misprediction value for each of the groups.

29. The memory management system of claim 28, in which the groups are chosen based on at least one of: a respective predictor confidence level; a respective process identifier; a respective address space identifier; and a respective virtual memory region.

30. The memory management system of claim 27, in which the prefaulting software component is further configured:
to deliberately refrain from performing the selective prefaulting for a subset of predicted memory pages; and
to estimate the misprediction value as a function of observed actual page faults.

31. The memory management system of claim 27, in which the cost-benefit software component is configured to derive the misprediction value P_{bad} by:
clearing access indicators associated with the prefaulted memory pages upon prefaulting the memory pages; and
scanning the access indicators and identifying which of the prefaulted memory pages have been accessed since a previous identification time after clearing of the access indicators.

32. The memory management system of claim 26, in which the prefaulting software component is further configured, as part of the selective prefaulting, to invoke a page fault earlier than it would otherwise occur by causing a user-mode thread to access the selectively prefaulted at least one memory page.

33. The memory management system of claim 26, in which the prefaulting software component operates asynchronously with respect to execution of the application.
